(19) United States
(12) Patent Application Publication
(10) Pub. No.: US 2013/0115375 A1
(43) Pub. Date: May 9, 2013

(54) STONE SEALING SYSTEMS AND METHODS

(71) Applicant: Justin Howe, Amarillo, TX (US)

(72) Inventor: Justin Howe, Amarillo, TX (US)

(21) Appl. No.: 13/288,923

(22) Filed: Nov. 3, 2011

(51) Int. Cl. B05D 3/02; B05C 5/00

(52) U.S. Cl. 427/314; 118/712; 118/300

(57) ABSTRACT

This disclosure is related to systems and methods of sealing a stone and is particularly useful for sealing a stone countertop, though it could also be applied to stone tiles or other types of stone products. In one example, a method for sealing stone may include applying heat to a stone and applying a sealant to the stone when the temperature of the stone is above a temperature threshold. The sealant may be an impregnating sealer.

### BACKGROUND

1. Field of the Invention

The present disclosure is generally related to a stone sealing system and method and, more specifically, to a system and method of sealing stone countertops.

2. Description of the Related Art

Many homeowners enjoy having stone in their houses, such as counter tops or flooring. Some types of natural stone commonly used in households include marble, granite, travertine, limestone, slate, and sandstone. While such types of stones can be naturally beautiful, they are also naturally porous and therefore must be sealed to provide a stain resistant surface to protect the surface from staining Also, various synthetic stones also need to be sealed to provide a stain resistant surface to protect the surface from staining

However, many of the commercially available sealants do not actually prevent stains and include difficult application procedures after the stone has been installed. Further, some sealants require periodic re-application of the sealant.

### BRIEF DESCRIPTION OF THE DRAWINGS

FIG. 1 is a diagram of an illustrative embodiment of a system for sealing stone; and

FIG. 2 is a diagram of another illustrative embodiment of a stone sealing method.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

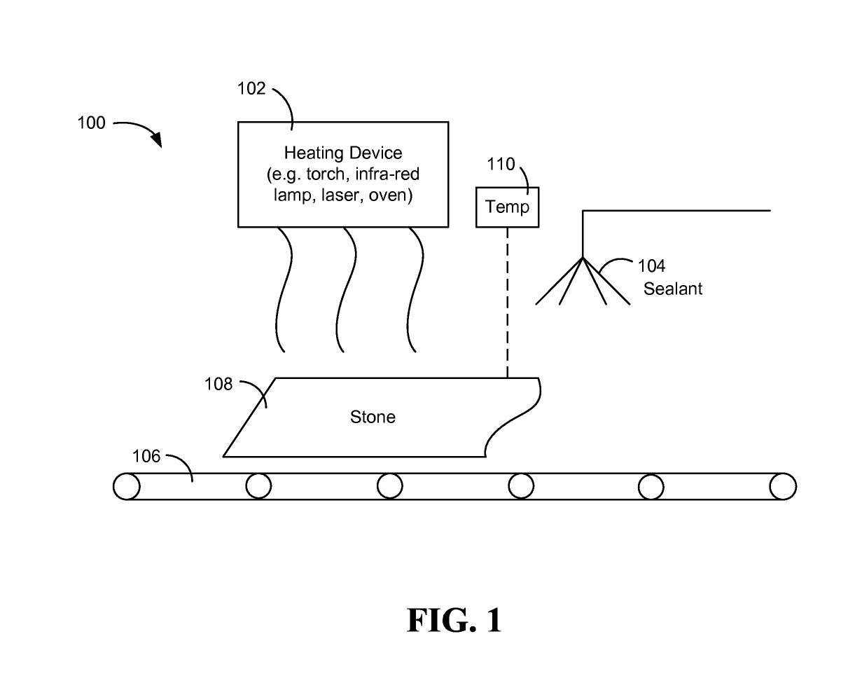

Referring to FIG. 1, a particular embodiment of a system for sealing stone is shown and generally designated 100. The system 100 may include a heating device 102 and a sealant applicator 104. The system 100 may also include a conveyor 106 or other components to implement an automated stone sealing method, such as a control system or computer (not shown). However, the system 100 may also be implemented by manual means.

During operation, the system 100 may seal a stone 108, such as a fabricated stone countertop or stone slab, by applying heat to the stone 108 via the heating device 102. The stone 108 may be dried prior to heating. In one particular embodiment, the stone may granite. The stone may also have a polished surface.

The heating device 102 may be any type of heating device, including infra-red lamp(s), lasers, torches, ovens, any other device capable of heating a stone, or any combination thereof. The surface of the stone 108 may be heated to a threshold temperature at which time the sealant may be applied via the sealant applicator 104. For example, the sealant may be Eco Star Stone Impregnator which can make the stone oil and stain resistant or another sealant that also provides such protections to the stone. The surface temperature of the stone 108 may be measured by any type of temperature measurement device, such as an infra-red thermometer 110.

The threshold temperature may be a minimum temperature at which the surface of the stone 108 should be before applying the sealant. In one embodiment, the threshold temperature may be 115 degrees Fahrenheit, and the sealant may be applied when the surface of the stone is between 115 and 125 degrees Fahrenheit. Preferably, the sealant is applied to the stone 108 when the surface temperature of the stone 108 is at or above the threshold temperature.

The heat can completely evaporate any remaining moisture from the surface of the stone 108 and can also open the pores in the stone 108 to be larger as the temperature rises. The stone 108 may also shrink and reveal larger pores, fishers, cracks, etc., which allows the impregnating sealer (also may be referred to as a penetrating sealer) to penetrate deep into the stone 108 and completely seal the surface as the stone 108 cools. This method renders the stone's surface stain resistant. An impregnating sealer can have an active component that is either a natural or a synthetic resin, which the resin can be melted into a liquid solution with a mineral solvent or with water.

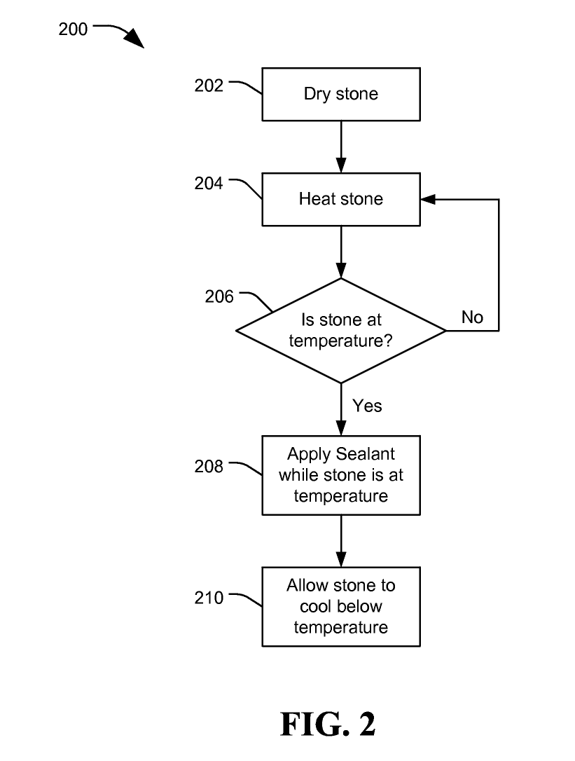

Referring to FIG. 2, a particular embodiment of a stone sealing method is shown and generally designated 200. The method 200 may include drying a stone, at 202. The stone may be a fabricated stone countertop or stone slab, including various types of natural stone. The drying process allows moisture to be removed from the stone.

The method may then apply heat to the stone, at 204, to reach a predetermined temperature threshold. If the temperature is not at the threshold, at 206, the method 200 may keep heating the stone, at 204. In a particular embodiment, the temperature threshold is 115 degrees. The heat allows any remaining moisture to evaporate from the stone while the pores in the stone open wider as the temperature rises. Also, the heat allows any gaps, cracks, or fishers to open. The heat may be applied from any heat source, such as a torch, infra-red lamp, laser, or oven.

When the temperature is at or above the temperature threshold, the sealant can be applied, at 208, such as the Eco Star impregnating sealer. The heated stone, having wider pores and more cracks, gaps, and fishers open allows the sealant to penetrate deeper into the stone. The sealant will seal the stone as the stone cools and render the stone's surface stain resistant. The stone may not be allowed to cool below the temperature threshold until after the sealant has been applied, at 210, or after a predetermined time after the sealant was applied.

The methods of sealing stone disclosed herein can be done at manufacturing or at a warehouse or by a wholesaler. Further, the methods described herein may be implemented as manual or automated methods. The methods described herein are particularly useful for sealing a stone countertop, though it could also be used to seal stone tiles or any other type of stone products.

The methods of sealing described herein are an improvement over previous methods because the methods include fewer steps than other methods, include fewer coatings than some methods, the sealant does not need re-application, and the sealing method can be performed prior to installation. Further, there is no need for multiple types of coatings or a base coat for the sealant and there is no need for ultraviolet treatment of applied topcoats.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method for sealing stone comprising:
applying heat to a stone;
applying a sealant to the stone when the temperature of the stone is above a temperature threshold.

2. The method of claim 1 further comprising:
at least partially drying the stone prior to applying the heat.

3. The method of claim 1 wherein the stone comprises natural stone.

4. The method of claim 1 wherein the stone comprises a fabricated stone countertop.

5. The method of claim 4 wherein the stone comprises a granite countertop with a polished surface.

6. The method of claim 1 further comprising measuring a surface temperature of the stone.

7. The method of claim 1 wherein the temperature threshold is 115 degrees Fahrenheit.

8. The method of claim 1 further comprising applying the sealant to the stone when a temperature of the stone is between 115 degrees and 125 degrees Fahrenheit.

9. The method of claim 1 wherein the sealant further comprises an impregnating sealer.

10. The method of claim 1 further comprising allowing the stone to cool below the temperature threshold after the sealant has been applied.

11. A system for sealing stone comprising:
a heat source to apply heat to a stone; and
an applicator to apply a sealant to the stone when the temperature of the stone is above a temperature threshold.

12. The system of claim 11 further comprising:
at least partially drying the stone prior to applying the heat.

13. The system of claim 11 wherein the stone comprises natural stone.

14. The system of claim 11 wherein the stone comprises a fabricated stone countertop.

15. The system of claim 14 wherein the stone comprises a granite countertop with a polished surface.

16. The system of claim 11 further comprising a temperature measurement device to measure a surface temperature of the stone.

17. The system of claim 11 wherein the temperature threshold is 115 degrees Fahrenheit.

18. The system of claim 11 further comprising applying the sealant to the stone when a temperature of the stone is between 115 degrees and 125 degrees Fahrenheit.

19. The system of claim 11 wherein the sealant further comprises an impregnating sealer.

20. The system of claim 11 further comprising allowing the stone to cool below the temperature threshold after the sealant has been applied.
